(19) United States
(12) Patent Application Publication
(10) Pub. No.: US 2024/0151909 A1
(43) Pub. Date: May 9, 2024

(54) OPTICAL CROSS-CONNECT DEVICE

(71) Applicant: NIPPON TELEGRAPH AND TELEPHONE CORPORATION, Tokyo (JP)

(72) Inventors: Chisato FUKAI, Musashino-shi, Tokyo (JP); Kunihiro TOGE, Musashino-shi, Tokyo (JP); Tomohiro KAWANO, Musashino-shi, Tokyo (JP)

(73) Assignee: NIPPON TELEGRAPH AND TELEPHONE CORPORATION, Tokyo (JP)

(21) Appl. No.: 18/272,644

(22) PCT Filed: Jan. 29, 2021
(86) PCT No.: PCT/JP2021/003164

§ 371 Date: Jul. 17, 2023

(51) Int. Cl. G02B 6/35

(52) U.S. Cl. CPC G02B 6/3504

(57) ABSTRACT

An object of the present disclosure is to reduce transmission loss deviation between ports in an optical cross-connect device using a rotary optical switch.

The present disclosure is an optical cross-connect device in which optical switches for switching a plurality of optical paths using optical fibers are connected to each other using optical paths, the optical switch collectively switches the plurality of optical paths using a rotating body, and the optical cross-connect device includes: a cross wiring part which connects an optical path having a large loss in one of the optical switches among the plurality of optical paths which are switched collectively and an optical path having a small loss in the other optical switch of the plurality of optical paths which are switched collectively to an optical path connecting the optical switches to each other.

### TECHNICAL FIELD

The present disclosure relates to an optical cross-connect device which switches a path of an optical fiber line using an optical fiber.

### BACKGROUND ART

Economical rotary optical switches in which a collimator, a lens, and the like are not required have been proposed by installing an optical fiber having a plurality of optical fiber lines on a rotating body and rotating the rotating body using an actuator (for example, refer to PTL 1). Optical cross-connect device having mxn (m and n are natural numbers of 2 or more) or n×n route switching can be configured by further connecting a plurality of these to each other and using them. Furthermore, it is also possible to collectively switch the optical fiber tape core wires by disposing the optical fiber tape core wires in which a plurality of optical fibers are integrated so that the optical fibers are aligned radially on the end surface of the rotating body.

However, as the number of core wires in the optical fiber tape increases and a distance from the center of the rotating body to the outside increases in the disposition of the optical fibers on the end surface of the rotating body, there is a problem that an amount of deviation of an optical axis with respect to a rotation angle error of the actuator becomes large and transmission loss deviation between ports becomes large.

### CITATION LIST

### Patent Literature

[PTL 1] Japanese Patent Application Publication No. H2-082212

### SUMMARY OF INVENTION

### Technical Problem

An object of the present disclosure is to reduce a transmission loss deviation between ports in an optical cross-connect device using a rotary optical switch.

### Solution to Problem

An optical cross-connect device of the present disclosure is an optical cross-connect device in which optical switches for switching a plurality of optical paths using optical fibers are connected to each other using optical paths, wherein the optical switch collectively switches the plurality of optical paths using a rotating body, and

the optical cross-connect device includes: a cross wiring part which connects an optical path having a large loss in one of the optical switches among the plurality of optical paths which are switched collectively and an optical path having a small loss in the other optical switch of the plurality of optical paths which are switched collectively to an optical path connecting the optical switches to each other.

### Advantageous Effects of Invention

According to the present disclosure, in an optical cross-connect device including a plurality of rotary optical switches for switching optical paths by rotating a rotating body having a plurality of optical paths, a loss difference of the plurality of optical paths having different distances from the center of the rotating body can be reduced. Thus, it is possible to reduce transmission loss deviation between ports and reduce a maximum transmission loss.

### BRIEF DESCRIPTION OF DRAWINGS

FIG. 1 is a block diagram showing an optical cross-connect device according to an embodiment of the present disclosure.

FIG. 2 is a configuration diagram of a 1×N rotary optical switch according to the embodiment of the present disclosure.

FIG. 3 is a configuration diagram showing a cross section of a ferrule having a plurality of optical paths installed therein according to the embodiment of the present disclosure.

FIG. 4 is a configuration diagram showing a cross section of a ferrule having a plurality of optical paths installed therein according to the embodiment of the present disclosure.

FIG. 5 is a diagram showing an example of a relationship between static angular accuracy and excess loss due to rotational misalignment.

FIG. 6 is a diagram showing a cross wiring part between optical switches according to the embodiment of the present disclosure.

### DESCRIPTION OF EMBODIMENTS

Embodiments of the present disclosure will be described in detail below with reference to the drawings. Note that the present disclosure is not limited to the embodiments shown below. These implementation examples are merely illustrative and the present disclosure can be implemented in various modified and improved forms on the basis of the knowledge of those skilled in the art. Note that, in this specification and the drawings, constituent elements having the same reference numerals are the same as each other.

Embodiments of the present disclosure will be described in detail below with reference to the drawings.

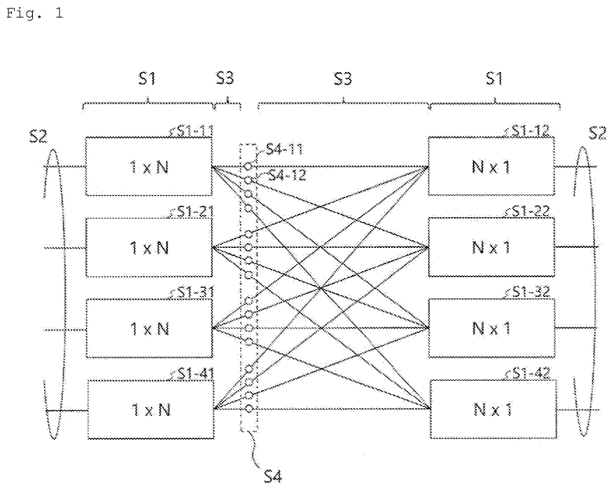

FIG. 1 is a block configuration diagram showing an optical cross-connect device according to an embodiment of the present disclosure. Here, FIG. 1 shows, as an example, a case of a complete non-blocking optical cross-connect device having 4 input paths S2 and 4 output paths S2 in which a plurality of 1×N (N is a natural number of 1 to 4) rotary optical switches S1 and a plurality of N×1 rotary optical switches S1 whose directions are bilaterally symmetrical are disposed on the input and output sides, respectively. Note that, although N is a natural number from 1 to 4, N may be any number of input/output paths and is not limited to this.

Furthermore, the number of input/output paths is not the same and if the included rotary optical switch and a wiring thereof are changed, an optical cross-connect device having an asymmetrical number of input/output paths can also be implemented. In addition, although the input and output are wired to each other (S3 part) in FIG. 1, the 1×N rotary optical switches S1 on the input side may be wired together. That is to say, the present disclosure may be configured to pass through at least two 1×N rotary optical switches S1 on the optical path.

Each component function of the optical cross-connect device shown in the drawing will be described below.

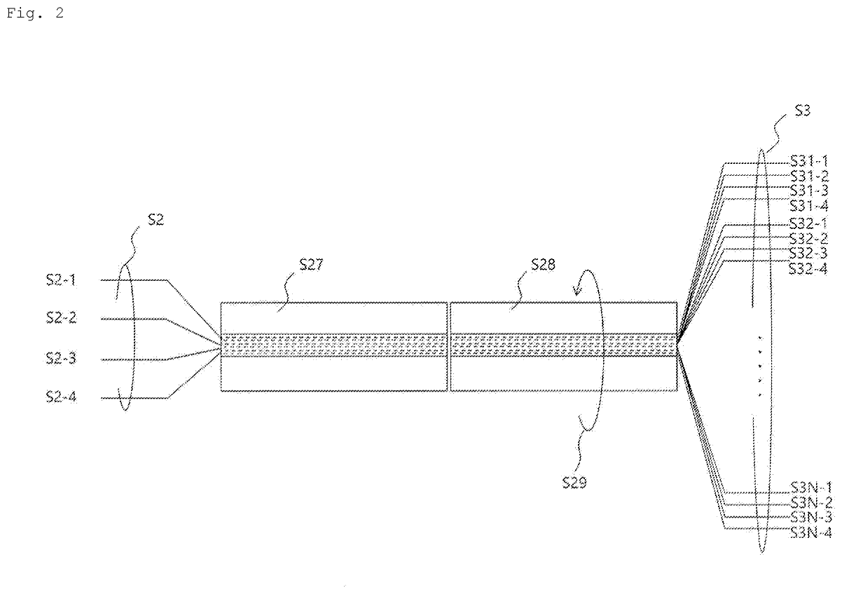

FIG. 2 is a configuration diagram of a 1×N rotary optical switch S1 according to the embodiment of the present disclosure. As shown in FIG. 2, the 1×N rotary optical switch has a plurality of optical paths S2-x (x is a natural number of 1 to 4) as one input route and is installed on a ferrule S27 having a cylindrical outer diameter. On the opposite side, a plurality of optical paths S3N-x are used as one route and this is provided as an output route of N routes. Similarly, this is installed on a ferrule S28 having a cylindrical outer diameter. One of the two ferrules is imparted with a rotational motion S29 to the other, thereby imparting a rotational motion to the ferrule S28 at every arbitrary rotational angle step. This is characterized in that switching of a plurality of optical paths is performed collectively.

For example, when a rotation angle of the ferrule S28 is 0 degrees, an optical path S2-x is connected to an optical path S31-x. When the rotary optical switch S1 is the rotary optical switch S1-11 shown in FIG. 1 and the optical path S31-x is connected to the rotary optical switch S1-12 shown in FIG. 1, the optical path S2-x connected to the rotary optical switch S1-11 can be connected to the optical path S2-x connected to the rotary optical switch S1-12 by setting the rotation angle of the ferrule S28 to 0 degrees.

For example, when the rotation angle of ferrule S28 is 45 degrees, the optical path S2-x is connected to the optical path S32-x. When the rotary optical switch S1 is the rotary optical switch S1-11 shown in FIG. 1 and the optical path S32-x is connected to the rotary optical switch S1-22 shown in FIG. 1, the optical path S2-x connected to rotary optical switch S1-11 can be connected to the optical path S2-x connected to rotary optical switch S1-22 by setting the rotation angle of the ferrule S28 to 45 degrees.

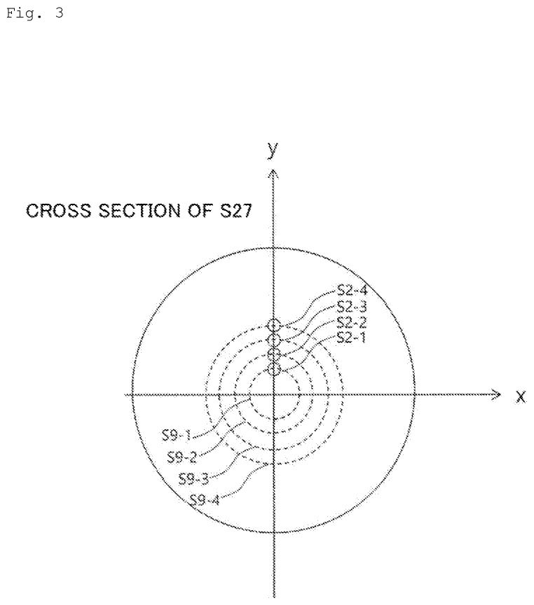

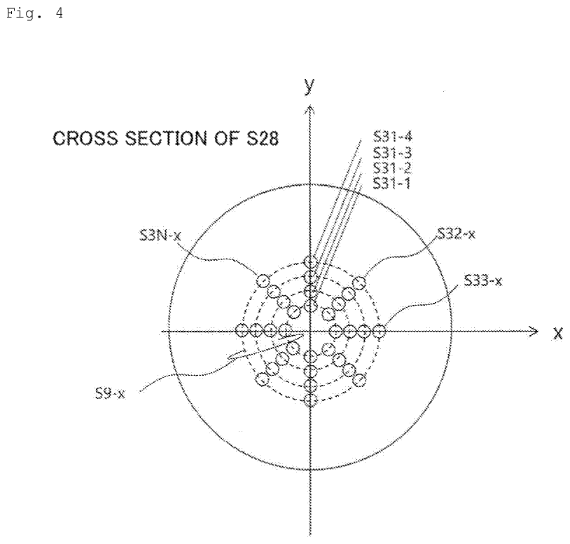

FIGS. 3 and 4 are configuration diagrams showing cross sections of the ferrule S27 and the ferrule S28, respectively, when the plurality of optical paths S2-x and S3N-x are installed on the ferrule S27 and the ferrule S28, respectively. As shown in FIGS. 3 and 4, when a center of the ferrule is taken as a central axis, core disposition radii S9-x which are the distances from four different central axes are set for the ferrule S27 in ascending order so that they are S9-1, S9-2, S9-3, and S9-4 from the central axis and the optical paths S2-x are similarly arranged in ascending order of S2-1, S2-2, S2-3, and S2-4 from the center axis at the same rotation angle. On the other hand, in the ferrule S28, N sets of optical paths S3N-x are arranged concentrically with the core disposition radius S9-x for each rotation angle and S3N-1, S3N-2, S3N-3, and S3N-4 are arranged in ascending order from the center.

Note that, as a method for realizing the optical path arrangement shown in FIGS. 3 and 4, for example, this may be realized using an optical fiber having a plurality of cores in one clad such as a multi-core optical fiber or a plurality of optical fibers having a single core may be installed at a plurality of optical fiber conduction holes provided in the ferrule. For example, instead of the ferrules 27 and 28, multi-core optical fibers may be employed and the cores of the multi-core optical fibers may be coupled together. Thus, the present disclosure allows both of the two rotating bodies to be ferrules or multi-core optical fibers.

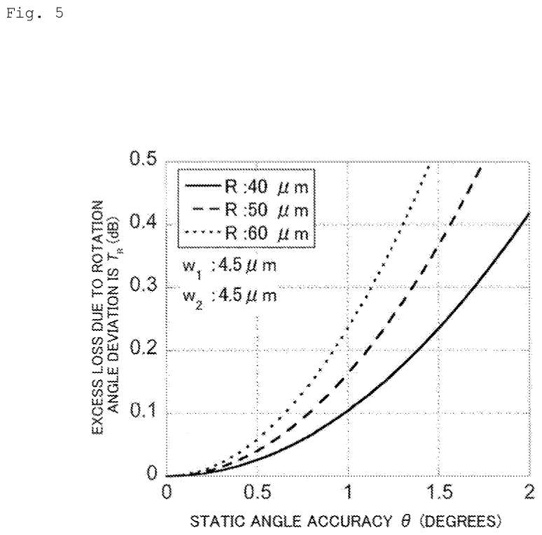

FIG. 5 is a diagram showing a relationship of excess loss due to rotation angle deviation to stationary angle accuracy in optical path rotation. Excess loss T_{R} (unit: dB) due to rotational angle deviation in each optical path can be expressed by the following equation using a core disposition radius R (unit: μm), a static angle accuracy θ (unit: degree) in optical path rotation, and mode field radii w₁ and w₂ of the optical path on the input side and the output side.

$${T}_{R} = {( \frac{2 {w}_{1} {w}_{2}}{{w}_{1}^{2} + {w}_{2}^{2}} )}^{2} exp [ 1 \frac{2 {( 2 R sin 2 π \frac{θ}{360} )}^{2}}{{w}_{1}^{2} + {w}_{2}^{2}} ] \qquad [ Math . 1 ]$$

From FIG. 5, when the mode field radii w₁ and w₂ are 4.5 μm, the excess loss T_{R} increases as the static angle accuracy θ increases, degrading the connection characteristics. Also, FIG. 5 shows an example in which the core disposition radius R is 40 μm, 50 μm, and 60 μm. As is clear from these comparisons, it can be seen that the connection loss increases as the core arrangement radius increases.

Therefore, the present disclosure provides a cross wiring part S4 in the optical path S3 connecting the rotary optical switches S1 to each other, as shown in FIG. 1. For example, the cross wiring part S4-11 connecting the rotary optical switches S1-11 and S1-12 connects a large-loss optical path in the rotary optical switch S1-11 and a small-loss optical path in the rotary optical switch S1-12 to each other.

Specifically, the transmission loss in the rotary optical switch S1-11 is smaller in the order of the optical path S31-1, the optical path S31-2, the optical path S31-3, and the optical path S31-4 shown in FIG. 4. Also in the rotary optical switch S1-12, the optical path S31-1, the optical path S31-2, the optical path S31-3, and the optical path S31-4 shown in FIG. 4 are smaller in this order. In such a case, the cross wiring part S4-11 connecting the rotary optical switches S1-11 and S1-21 connects the large-loss optical path S31-4 in the rotary optical switch S1-11 and the small-loss optical path S31-1 in the rotary optical switch S1-12.

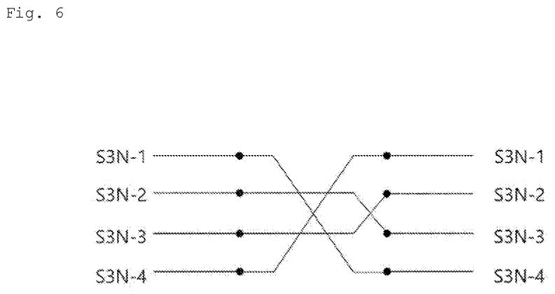

FIG. 6 is a diagram showing the details of the cross wiring part S4 provided in the middle of the wiring S3 part between the 1×N rotary optical switches S1 in FIG. 1. As shown in FIG. 6, a cross wiring part is provided in which one optical path is disposed in descending order and the other optical path is disposed in ascending order and connected to each other.

For example, in the case of an optical path connecting the rotary optical switch S1-11 and the rotary optical switch S1-12, the optical paths connected to the rotary optical switch S1-11 of the cross wiring section S4-11 are disposed in the order of the optical path S31-1, the optical path S31-2, the optical path S31-3, and the optical path S31-4 so that the magnitude of the loss in the rotary optical switch S1-11 is in ascending order. On the other hand, the optical paths connected to the rotary optical switch S1-12 of the cross wiring part S4-11 are disposed in the order of the optical path S31-4, the optical path S31-3, the optical path S31-2, and the optical path S31-1 so that the magnitude of the loss in the rotary optical switch S1-12 is in descending order.

As described above, the present disclosure includes a cross wiring part in a wiring which connects between two 1×N rotary optical switches of an optical cross-connect device which transmits the two 1×N rotary optical switches for one input/output optical path. According to the present disclosure, when optical paths in descending order from the optical paths having the smaller core disposition radii are connected to the optical paths in ascending order in the cross wiring part, it is possible to make the sum of the optical axis deviation amounts at the input and output approximately equal and it is possible to reduce the optical loss deviation caused by the optical axis shift with respect to the rotation angle error due to the difference in the core arrangement radius of the optical path in the optical cross-connect device.

Thus, the present disclosure can provide an optical cross-connect device for use in an optical fiber network which can satisfy strict loss budget requirements between transmission devices required in access networks and the like. Furthermore, the present disclosure facilitates the installation and loss design of a transmission device having an optical cross-connect function, thus facilitating the realization of an optical fiber network having an optical cross-connect function.

Note that, needless to say, it can also be implemented in the case of another aspect without departing from the scope of the present disclosure, for example, when the number of routes N of the 1-route×N-routes rotary optical switch is larger than that of this embodiment or the number x of a plurality of optical paths in one route is larger than that of the embodiment. Furthermore, for example, the present disclosure can also be applied to when the optical path arrangement of one ferrule of the rotary optical switch is changed to change the configuration of the rotary optical switch, such as 2-routes×N-routes and when constructing a large-scale optical cross-connect device by using two or more rotary optical switches for one input/output optical path, for example, two-stage rotary optical switches on the input/output side.

### INDUSTRIAL APPLICABILITY

In view of the above effects, the optical switch according to the present disclosure can be used as a low-loss and economical optical cross-connect device in an optical transmission line using a single-mode optical fiber, for example, in an optical access transmission line in which particularly strict low-loss requirements are required.

### REFERENCE SIGNS LIST

S1, S1-11, S1-21, S1-31, S1-41, S1-12, S1-22, S1-32, S1-42 Optical switch
S2 Input/output optical path
S2-x Optical path
S27 Ferrule
S28 Ferrule
S29 Rotational motion
S3 Wiring
S3N-x Optical path
S4, S4-11, S4-12 Cross wiring part
S9-x Core disposition radius

1. An optical cross-connect device in which optical switches for switching a plurality of optical paths using optical fibers are connected to each other using optical paths, wherein
the optical switch collectively switches the plurality of optical paths using a rotating body, and
the optical cross-connect device includes:
a cross wiring part which connects an optical path having a large loss in one of the optical switches among the plurality of optical paths which are switched collectively and an optical path having a small loss in the other optical switch of the plurality of optical paths which are switched collectively to an optical path connecting the optical switches to each other.

2. The optical cross-connect device according to claim 1, wherein the optical switch has a cylindrical shape and includes two rotating bodies in which the plurality of optical paths are disposed at different distances from a central axis of the cylindrical shape, and
the plurality of optical paths are switched collectively by rotating one of the two rotating bodies with respect to the other.

3. The optical cross-connect device according to claim 2, wherein the other of the two rotating bodies is at the same distance from the central axis of the cylindrical shape as the one of the two rotating bodies and the plurality of optical paths are disposed at a plurality of rotation angles.

4. The optical cross-connect device according to claim 2, wherein the two rotating bodies are
ferrules for fixing optical fibers at a plurality of predetermined positions in a cylindrical shape or
multi-core optical fibers having cores at a plurality of predetermined positions in a cylindrical shape.

5. The optical cross-connect device according to claim 1, wherein the optical paths connected to the one optical switch in the cross wiring part are disposed in ascending order of a magnitude of loss in the one optical switch, and
the optical paths connected to the other optical switch in the cross wiring part are disposed in descending order of a magnitude of loss in the other optical switch.
